(19) United States
(12) Patent Application Publication
(10) Pub. No.: US 2007/0027976 A1
(43) Pub. Date: Feb. 1, 2007

(54) Multicast delivery method, system, and content server

(76) Inventors: Kazuhiro Sasame, Yokohama (JP); Yosuke Takahashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/476,726

(22) Filed: Jun. 29, 2006

(30) Foreign Application Priority Data
Jul. 27, 2005 (JP) 2005-217199

(51) Int. Cl. G06F 15/173

(52) U.S. Cl. 709/223

(57) ABSTRACT

If a failure occurs in a content server having a function to deliver a content as a multicast IP packet, the influence on the end user is minimized. An active content server and a standby content server are provided. The active content server delivers a multicast content, and the standby content server joins a corresponding multicast group, receives the multicast packet sent by the active content server, and monitors the delivery status of the active content server. If no multicast packet is delivered from the active content server before the scheduled end of the content delivery determined by the content delivery end information (content length in time, sequence number, or absolute end time) specified in each content, the standby content server starts the multicast content delivery.

### BACKGROUND OF THE INVENTION

1. Field of the Invention

The present invention relates to multicast delivery methods, systems, and content servers, and more specifically, to a multicast delivery method, system (including a mobile communication system), and content server for delivering a content such as video and music in the form of multicast IP packet.

2. Description of the Related Art

The recent development of communication technologies has been diversifying the styles of services utilizing a communication network and provided for end users. One of those services delivers music and video contents to the end users. The conventional service delivers a content each time it is accessed by an end user. As the number of end users of the service is increasing, the load on the content server for delivering the content and the resources used to deliver the contents are increasing. As an efficient content delivery method which solves those problems, a multicast content delivery service is starting.

A multicast delivery system includes a content server which has a function to send a content as multicast IP packets, a network which has a function to transfer the multicast IP packets to an end node, and a terminal which has functions to receive the multicast IP packets and to reproduce the content.

The multicast content delivery system can be greatly effective in reducing the load on the content server and the resources used for content delivery. However, because the end users share the common multicast data, it becomes a big concern that a multicast data transfer failure would affect a great number of end users simultaneously.

One conventional method of improving reliability in that type of multicast content delivery notes an intermediate transfer path of the multicast IP packets between the content server and the end user.

Examples of the conventional method are disclosed in Japanese Unexamined Patent Application Publication No. 2005-20327 as “Multicast delivery method, delivery apparatus, and system” and in Japanese Unexamined Patent Application Publication No. 2003-124930 as “Multicast delivery method and delivery server.”

The method disclosed as “Multicast delivery method, delivery apparatus, and system” in Japanese Unexamined Patent Application Publication No. 2005-20327 assumes that the invention is applied to a mobile communication system. The multicast data sent by the content server is transferred to a network into which the mobile terminal has moved. This reduces the resources of the transfer network and improves the reliability of content delivery to the destination.

In the method disclosed as “Multicast delivery method and delivery server” in Japanese Unexamined Patent Application Publication No. 2003-124930, the delivery server automatically switches between the satellite and terrestrial content delivery paths to the end user in the event of a failure in an intermediate transfer path, consequently improving the reliability of content delivery.

The reliability of the content server itself can also be improved by providing a redundant content server.

One such method uses an active content server which performs multicast delivery and a standby content server which can perform content delivery on behalf of the active content server if a failure occurs in the active content server.

In the even of a failure in the active content server, the standby content server redelivers the content or delivers a special “Thank you for your patience” screen or an infomercial content, so that the content delivery will not stop and the reliability will be improved.

Another method performs concurrent content delivery by the active and standby content servers. If a failure occurs in one content server, the other content server can continue the delivery. One example of this delivery method is disclosed in Japanese Unexamined Patent Application Publication No. Hei-9-224233 as “Redundant communication system.”

The method disclosed as “Redundant communication system” in Japanese Unexamined Patent Application Publication No. Hei-9-224233 uses redundant transmission paths and redundant transmission apparatuses, in order to improve the reliability of content delivery. The two redundant transmission apparatuses deliver a content simultaneously, and signals are combined on the receiver side, so that the content can be viewed continuously even if a failure occurs in one transmission apparatus.

[Patent Document 1] Japanese Unexamined Patent Application Publication No. 2005-20327

[Patent Document 2] Japanese Unexamined Patent Application Publication No. 2003-124930

[Patent Document 3] Japanese Unexamined Patent Application Publication No. Hei-9-224233

### SUMMARY OF THE INVENTION

The method disclosed as “Multicast delivery method, delivery apparatus, and system” in Japanese Unexamined Patent Application Publication No. 2005-20327 and the method disclosed as “Multicast delivery method and delivery server” in Japanese Unexamined Patent Application Publication No. 2003-124930 intend to improve the reliability of content delivery by improving the reliability of the intermediate transfer path of multicast IP packets between the content server and the end user. These conventional methods use a single content server having a content delivery function. If a failure occurs in the content server, the content delivery will stop completely.

If an active content server and a standby content server are provided to allow switchover to the standby content server in the event of a failure in the active content server, the standby content server may deliver a special content provided for use in case of a failure (such as a “Thank you for your patience” screen and an infomercial content), preventing the user from listening to or watching continuously the content delivered from the active content server.

The standby content server may redeliver the content which was delivered by the active server. This causes two problems: The user is required to listen or watch the content from the beginning even if the user has already listened or watched some part of the content; and the program delivery schedule is delayed.

If the method disclosed as “Redundant communication system” in Japanese Unexamined Patent Application Publication No. Hei-9-224233 is applied as a multicast IP packet delivery method in a mobile communication system, the two redundant content servers send the same multicast IP packets simultaneously, and all the multicast IP packets are transferred to the end user. This wastes the limited wireless band of the mobile communication system. The received redundant packets may also affect the content reproduction function of the receiver side and could not be reproduced in some cases.

Accordingly, it is an object of the present invention to provide a multicast content delivery system including a content server with a function to send a content as multicast IP packets, the system minimizing the influence of any failure in the content server on the listening or watching of the user and improving the reliability of content delivery without wasting the limited wireless resources of a mobile communication system.

In order to solve the problems described earlier and to accomplish the object described above, the present invention provides an active multicast content delivery server and a standby multicast content delivery server. The system is configured by the active and standby content servers, a controller including a means of giving a content delivery start instruction or a content delivery stop instruction to the content servers, a multicast router for receiving and transferring multicast packets to an appropriate network, and a network for transferring the multicast packets to the multicast router and finally to the end user.

A multicast destination IP address, a destination port number, and a total content delivery time of each content identified by a content ID can be stored beforehand in the active and standby content servers. The total content delivery time may be replaced by a content delivery end time.

The controller can include a means of giving a content delivery start instruction or a content delivery stop instruction to the active and standby content servers by using a content ID as a key. The content delivery start instruction and the content delivery stop instruction may be given with reference to the content delivery start time and content delivery stop time stored beforehand or may be given by an apparatus disposed in a multicast packet transfer network.

The active content server may have a function to deliver a content as multicast IP packets having a registered multicast destination IP address and a destination port number when the controller gives a content delivery instruction using the content ID as a key.

The active content server may also have a function to add the lapse of time since the beginning of content delivery to the multicast IP packets to be sent. The lapse of time may be given as a sequence number or as an absolute time. If RTP is used as a protocol above UDP, an RTP sequence number may also be used.

The standby content server may have a means of joining a multicast group having the registered multicast destination IP address and the destination port number and receiving the multicast packets without starting multicast delivery immediately when the controller gives a content delivery instruction using the content ID as a key.

The standby content server may also have a means of receiving the multicast packets sent by the active content server for content delivery by means of the multicast packet receiving means and analyzing the lapse of time since the beginning of content delivery (the information can be a sequence number or absolute time), included in the packets.

The standby content server can further have a means of detecting the interruption of multicast packet delivery from the active content server because of an unexpected reason by detecting that the multicast packet delivery stops before the content end time, in accordance with the lapse of time since the beginning of content delivery and the total content delivery time. If the means of detecting the interruption of multicast packet delivery uses a sequence number, the interruption of the multicast packet delivery may be detected by confirming that the final sequence number has not been reached. If the absolute time is used, the interruption of the multicast packet delivery may be detected by confirming that nothing is received for a certain period of time before the end time.

The standby content server can have a means of starting the content delivery if the interruption of multicast packet delivery from the active content server has been detected by the means of detecting the interruption of multicast packet delivery from the active content server at an unexpected timing.

The standby content server can further include a means of determining a content delivery start point with reference to the sequence number or the lapse of time since the beginning of content delivery, included in the multicast packets last received from the active content server, if the standby content server starts the content delivery on behalf of the active content server.

The standby content server can also include a means of starting content delivery from the delivery start point determined by the means of determining a content delivery start point.

The standby content server may start delivery as described below.

The standby content server can have a means of turning a content into multicast IP packets and not sending the multicast packets but discarding the packets when a content delivery start instruction is given by the controller.

The standby content server can have a means of switching the packet discard processing to the packet transmission processing if the interruption of delivery from the active content server is detected while the standby content server is discarding the packets.

According to the first aspect of the present invention, it is provided a multicast delivery method for a multicast delivery system,

the multicast delivery system comprising:
an active content server and a standby content server for delivering a multicast packet containing content data; and
a multicast router for receiving the multicast packet delivered by the active content server and the standby content server and transferring the multicast packet to an interface corresponding to a multicast destination address, and

the multicast delivery method comprising the steps of:
the active content server holding content data and content management information that includes content identification information, a multicast content delivery destination address, and delivery end information, and delivering the multicast packet containing multicast management information and the content data through the multicast router;
the standby content server holding the same content management information and content data as the active content server;
the standby content server joining a multicast group of the multicast packet delivered by the active content server through the multicast router, in accordance with the content identification information and the multicast destination address of the multicast management information;
the standby content server receiving the multicast packet delivered by the active content server through the multicast router; and
if an interruption of the multicast packet delivery from the active content server is detected, the standby content server delivering the multicast packet containing the multicast management information and content data not delivered due to the interruption, through the multicast router on behalf of the active content server.

According to the second aspect of the present invention, it is provided a multicast delivery system comprising:
an active content server and a standby content server for delivering a multicast packet containing content data; and
a multicast router for receiving the multicast packet delivered by the active content server and the standby content server and transferring the multicast packet to an interface corresponding to a multicast destination address,
wherein the active content server holds content data and content management information that includes content identification information, a multicast content delivery destination address, and delivery end information, and delivers the multicast packet containing multicast management information and the content data through the multicast router;
the standby content server holds the same content management information and content data as the active content server;
the standby content server joins a multicast group of the multicast packet delivered by the active content server through the multicast router, in accordance with the content identification information and the multicast destination address of the multicast management information;
the standby content server receives the multicast packet delivered by the active content server through the multicast router; and
if an interruption of the multicast packet delivery from the active content server is detected, the standby content server delivers the multicast packet containing the multicast management information and content data not delivered due to the interruption, through the multicast router on behalf of the active content server.

According to the third aspect of the present invention, it is provided a content server for delivering a multicast packet containing content data through a multicast router for transferring the multicast packet to an interface corresponding to a multicast destination address;
the content server, when acting as an active content server, holding content data and content management information that includes content identification information, a multicast content delivery destination address, and delivery end information, and delivering the multicast packet containing the content data and multicast management information through the multicast router;
the content server, when acting as a standby content server, holding the same content data and content management information as the active content server;
the standby content server joining a multicast group of the multicast packet delivered by the active content server through the multicast router, in accordance with the content identification information and the multicast destination address of the multicast management information;
the standby content server receiving the multicast packet delivered by the active content server through the multicast router; and
if an interruption of the multicast packet delivery from the active content server is detected, the standby content server delivering the multicast packet containing the multicast management information and content data not delivered due to the interruption, through the multicast router on behalf of the active content server.

As has been described above, the content servers of the present invention deliver a content as multicast IP packets, and if the multicast packet delivery is interrupted by a failure in the active content server, the standby content server detects the fact and acts as a proxy in the content delivery, thus improving the reliability. Either the active content server or the standby content server sends the packets, so that the limited wireless resources of the mobile communication system will not be wasted. The standby content server can detect the point where the content delivery by the active content server was interrupted and resume the delivery from the interruption point, so that the end user can get good service.

### BRIEF DESCRIPTION OF THE DRAWINGS

FIG. 1 is an outline diagram showing the configuration of an entire system.

FIG. 2 is a functional block diagram of a controller.

FIG. 3 is a view showing details of content management information.

FIG. 4 is a functional block diagram of a content server.

FIG. 5 is a view showing an image of content data.

FIG. 6 is a view showing the structure of a delivery start request message.

FIG. 7 is a sequence diagram showing an example operation of a first embodiment.

FIG. 8 is a view showing the structure of a multicast IP packet.

FIG. 9 is a sequence diagram showing an operation of a second embodiment where a method of discarding packets is used.

FIG. 10 is a view showing the structure of a multicast IP packet without sequence number.

### DESCRIPTION OF THE PREFERRED EMBODIMENTS

Embodiments of the present invention will be described below with reference to the drawings.

1. Hardware

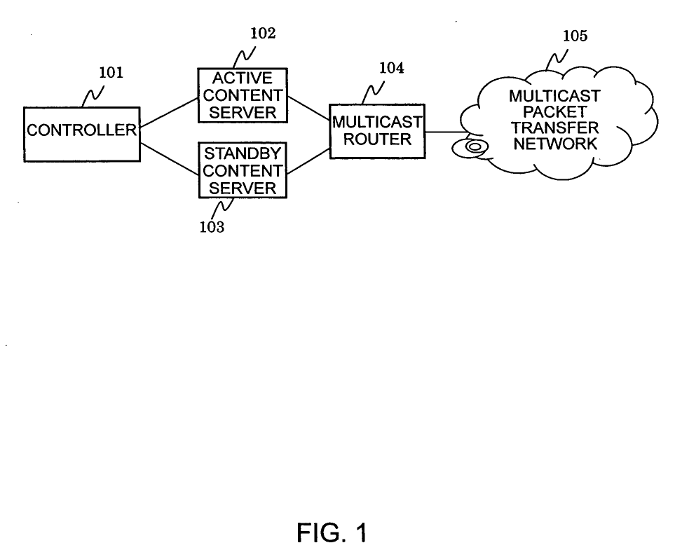

FIG. 1 is a diagram showing a system configuration of an embodiment of the present invention.

In FIG. 1, a controller 101 manages all the information of a content held by content servers and controls delivery by giving the content servers a content delivery start instruction or a content delivery stop instruction. An active content server 102 delivers content data held in a storage device as multicast IP packets when a content delivery start instruction is given by the controller 101. A standby content server 103 does not perform content delivery when a content delivery start instruction is given by the controller 101. The standby content server 103 receives the multicast packets sent by the active content server 102 and monitors the delivery status of the active content server by checking whether the multicast packets are received. A multicast router 104 receives the multicast packets sent by the content servers 102 and 103 and has a function to transfer the multicast packets to an appropriate interface or a multicast packet transfer network 105 when necessary. The multicast packet transfer network 105 has a function to transfer the multicast packets to an end user.

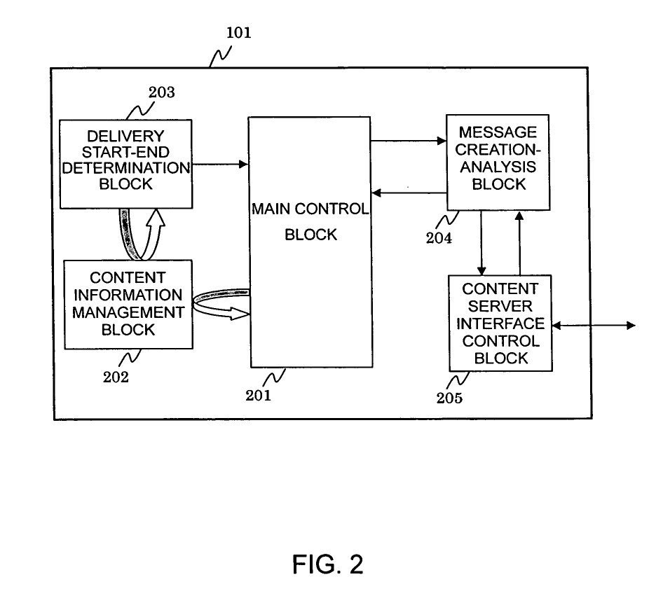

FIG. 2 is a block diagram showing the configuration of the controller 101 in the embodiment of the present invention.

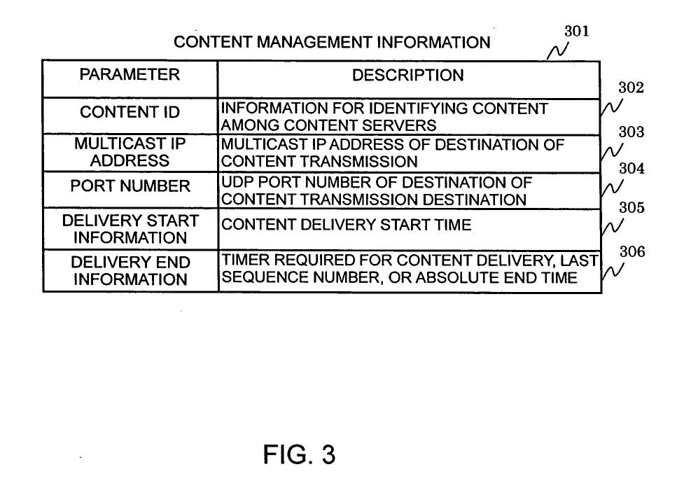

In FIG. 2, a main control block 201 controls the entire controller function. A content information management block 202 stores information (described later with reference to FIG. 3) of a content, which is needed when a delivery start instruction is sent to the content servers. A delivery start-end determination block 203 determines a content delivery start timing and a content delivery stop timing in accordance with delivery start information and delivery end information included in the content information stored in the content information management block 202. A message creation-analysis block 204 creates a delivery start request message or a delivery stop request message when the delivery start-end determination block 203 determines that the delivery should start or stop, and analyzes a response message from a content server. A content server interface control block 205 sends a delivery start request message or a delivery stop request message to the content server and receives a response message from the content server.

FIG. 3 shows a content information management table of information managed by the content information management block 202 of the controller 101.

In FIG. 3, the content information management table shown includes a content ID 302, a multicast IP address 303, a port number 304, delivery start information 305, and delivery end information 306. The content ID 302 is information for identifying a content uniquely among the controller 101, the active content server 102, and the standby content server 103. When the active content server 102 sends a content as multicast IP packets in response to a delivery start request received from the controller 101, the multicast IP address 303 is specified as the destination IP address of the multicast IP packets. When the active content server 102 sends a content as multicast IP packets in response to a delivery start request received from the controller 101, the port number 304 is specified as the destination port number in the UDP protocol in the transport protocol layer, above the IP protocol. The delivery start information 305 indicates timing when the controller 101 gives a content delivery start instruction to the active content server 102 and the standby content server 103. The delivery end information 306 indicates timing when the controller 101 gives a content delivery stop instruction to the active content server 102 and the standby content server 103.

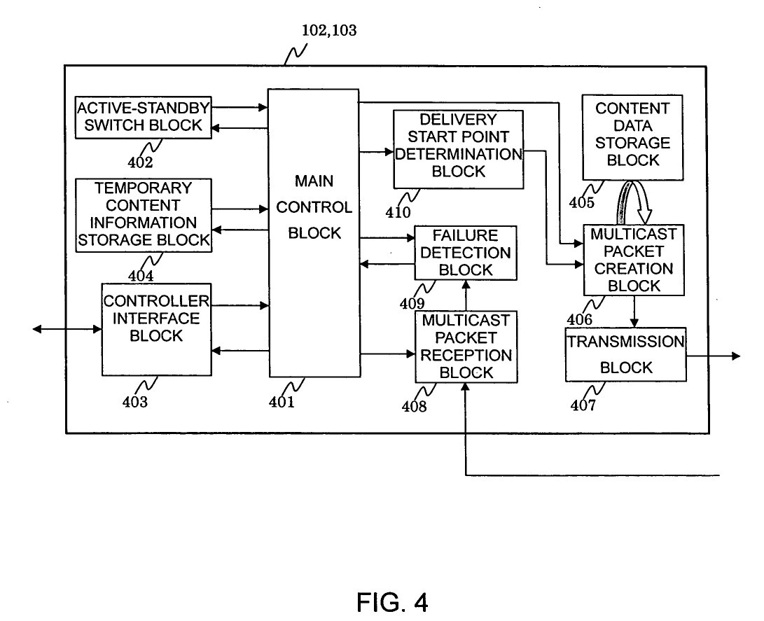

FIG. 4 is a block diagram showing an example configuration of the active content server 102 and the standby content server 103 of the embodiment of the present invention. The servers generally have the same software configuration but may have different software configurations.

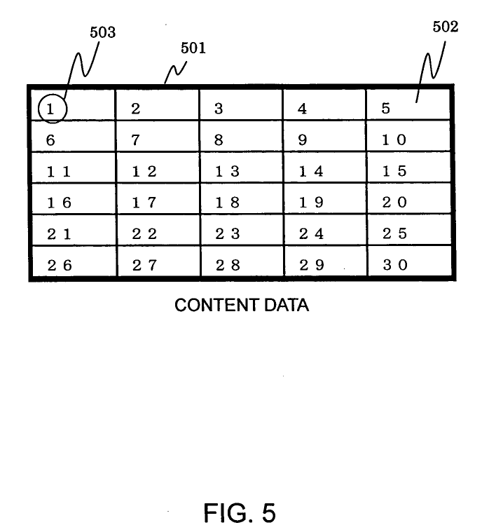

In FIG. 4, a main control block 401 controls the whole of the active content server 102 or the standby content server 103. An active-standby switch block 402 reports the main control block 401 whether the server operates in the active or standby mode. A controller interface block 403 receives a delivery start request or a delivery stop request from the controller 101 and sends a response to the controller 101. A temporary content information storage block 404 temporarily holds the content ID 302, the multicast IP address 303, the port number 304, and the delivery end information 306 received as parameters of a delivery start request message from the controller 101, until the end of the content delivery. A content data storage block 405 stores the content data to be delivered (a data storage image will be described with reference to FIG. 5), including the correspondence with the content ID 302. A multicast packet creation block 406 creates a multicast IP packet on the basis of the content data stored in the content data storage block 405, the information stored in the temporary content information storage block 404, and the delivery start point determined by a delivery start point determination block 410. A transmission block 407 sends the multicast IP packet created by the multicast packet creation block 406 to the interface (multicast router 104). A multicast packet reception block 408 of the standby content server 103 receives the multicast IP packet sent by the active content server 102, through the multicast router 104, by joining a multicast group of the multicast IP address 303 corresponding to the multicast destination IP address of the content. A failure detection block 409 of the standby content server 103 determines whether the multicast IP packets are normally delivered from the active content server 102, by analyzing the multicast IP packets received by the multicast packet reception block 408, and detects a failure occurring in the active content server 102 by recognizing that the multicast IP packets cannot be received before the end of content indicated by the delivery end information 306 stored in the temporary content information storage block 404 is reached. If the failure detection block 409 detects a failure in the active content server 102, the delivery start point determination block 410 of the standby content server 103 estimates an interruption point of the content delivery by the active content server 102 on the basis of the sequence number included in the normal multicast IP packet last received, and determines a point where the standby content server 103 should restart the content delivery.

FIG. 5 is a view showing typical data of one content stored beforehand in the content data storage blocks 405 of the active content server 102 and the standby content server 103. The same content data is stored in the active content server 102 and the standby content server 103.

In FIG. 5, content data 501 are the whole data of one content identified by a content ID. The content data 501 are divided into a plurality of segments 502 of an appropriate data size (each segment can be small enough to be included in a single multicast IP packet or large enough to be divided to a plurality of multicast IP packets), and each divided data segment is assigned a sequence number 503.

If the content data of the divided data segment 502 is sent as a multicast IP packet, a sequence number “5”, for instance, is assigned to the multicast IP packet. The content data is stored beforehand in both the active content server 102 and the standby content server 103.

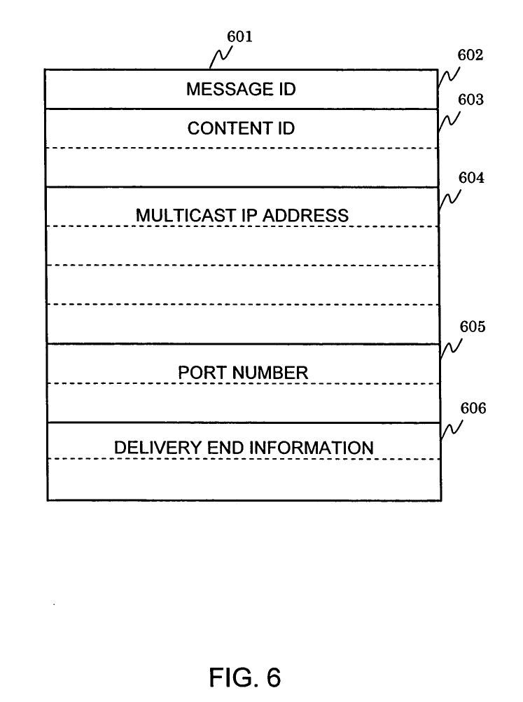

FIG. 6 shows the structure of a delivery start request message sent from the controller 101 to the active content server 102 and the standby content server 103 when the content delivery start time is reached.

A delivery start request message 601 shown in FIG. 6 is defined in the application layer, and this part is included in the payload field of the lower transfer protocol (corresponding to the UDP payload field if UDP/IP is used as the transfer protocol).

A message ID 602 indicates whether the message makes a delivery start request or a delivery stop request. A content ID 603 is information for identifying the content uniquely among the controller 101, the active content server 102, and the standby content server 103. A multicast IP address 604 is specified as the destination IP address of a multicast IP packet to be sent by the active content server 102. A port number 605 is specified as the destination port number of the multicast IP packet to be sent by the active content server 102. Delivery end information 606 is given so that the active content server 102 and the standby content server 103 know a content end timing.

The values of content management information 301 stored in the content information management block 202 of the controller 101 are specified as the content ID 603 to the delivery end information 606.

2. First Embodiment

(1) Multicast Packet Delivery

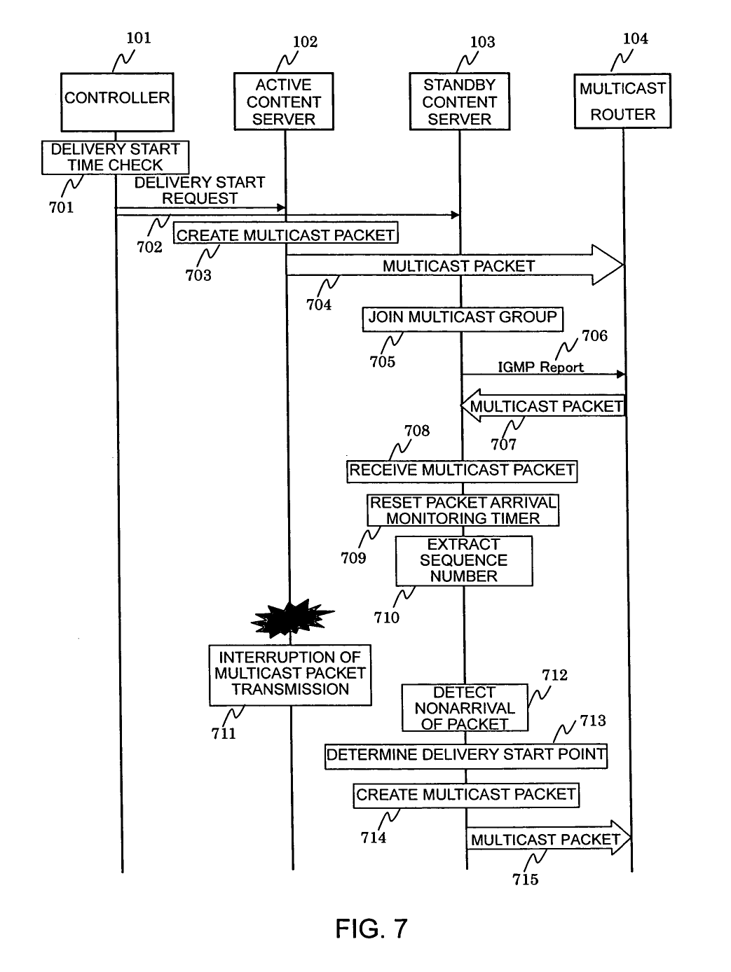

FIG. 7 is a sequence diagram showing an operation of a first embodiment of the present invention.

As shown in FIG. 7, the controller 101 controls content delivery made by the active and standby content servers. When the active content server 102 receives a delivery start instruction from the controller 101, the active content server 102 starts multicast content delivery in accordance with the content management information 301 included in the delivery start request message from the controller 101. When the standby content server 103 receives a delivery start instruction from the controller 101, the standby content server 103 receives multicast IP packets sent by the active content server 102 by joining the multicast group corresponding to the multicast IP address of the content management information 301 included in the delivery start request message from the controller 101, and monitors the multicast delivery status of the active content server 102. The multicast router 104 transfers the multicast IP packets to an appropriate network.

The operation conducted by the multicast delivery method of the present invention will be described with reference to FIG. 7.

The content management information 301 is specified beforehand in the content information management block 202 of the controller 101. The content file storage blocks 405 of the active content server 102 and the standby content server 103 store the raw data of a content in the format as indicated by the content data 501.

The delivery start-end determination block 203 of the controller 101 makes a delivery start time check (in step 701) by seeing the delivery start information 305 of the content management information 301 specified in the content information management block 202 periodically. When it determines that the current time and the delivery start information 305 match, the delivery start-end determination block 203 extracts the content ID 302, the multicast IP address 303, the port number 304, and the delivery end information 306 from the content management information 301 stored in the content information management block 202, and requests the message creation-analysis block 204 to create a delivery start request message.

The message creation-analysis block 204 creates a delivery start request message 601, specifying a message ID 602 representing a delivery start request, and sends the content delivery start request message to both the active content server 102 and the standby content server 103 (in step 702), in order to give a content delivery start instruction.

The active content server 102 is specified beforehand as an active one by the active-standby switch block 402. The active content server 102 receives the delivery start request message 601 from the controller 101 through the controller interface block 403, saves the content ID 603, the multicast IP address 604, the port number 605, and the delivery end information 606, which are parameters of the content management information 301 included in the delivery start request message, in the temporary content information storage block 404, and reports the content ID 603, the multicast IP address 604, and the port number 605 through the main control block 401 to the multicast packet creation block 406.

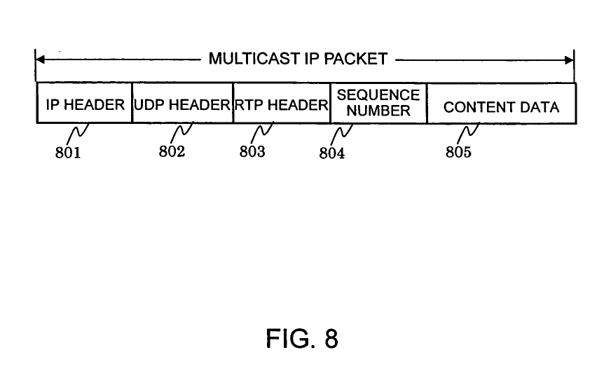

The multicast packet creation block 406 picks out the corresponding content data 501 from the content data storage block 405, using the content ID 603 reported from the main control block 401 as a key, and creates a multicast IP packet (in step 703), as shown in FIG. 8, by using the multicast IP address 604 and the port number 605 reported from the main control block 401 and the sequence number 503 included in the content data 501 taken out from the content data storage block 405.

FIG. 8 shows the format of a multicast IP packet.

As shown in FIG. 8, the created multicast IP packet includes an IP header field 801 where the multicast IP address 604 is specified as the destination IP address, an UDP header field 802 where the port number 605 is specified as the destination port number, an RTP header field 803, a sequence number field 804 where the sequence number 503 is specified, and a content data field 805.

The created multicast IP packets are sent successively from the transmission block 407 toward the external interface (multicast router 104) (in step 704) until the content delivery ends.

(2) Standby Content Server

The standby content server 103 is specified beforehand as a standby one by the active-standby switch block 402. The standby content server 103 receives the delivery start request message 601 from the controller 101 through the controller interface block 403, stores the content ID 603, the multicast IP address 604, the port number 605, and the delivery end information 606, which are parameters of the content management information 301 included in the delivery start request message 601, in the temporary content information storage block 404, and joins the multicast group having the multicast IP address 604 (binds a socket) (in step 705) to receive the multicast packets sent by the active content server 102 (in step 704).

At that time, the failure detection block 409 in the standby content server 103 starts a timer for monitoring the arrival of multicast IP packets expected to be received from the active content server 102.

When the standby content server 103 joins the multicast group (in step 705), an IGMP Report message 706 having the content ID and the multicast IP address 604 corresponding to the content is sent from the standby content server 103 to the multicast router (in step 706), by using the default multicast destination address.

The multicast router 104 receives the IGMP Report message sent by the standby content server 103 (in step 706) and starts transferring multicast packets having the destination IP address matching the multicast IP address 604 specified in the IGMP Report message to the interface connected to the standby content server 103 (in step 707).

In the standby content server 103 joining the multicast group concerning the multicast IP address 604 corresponding to the content, the multicast packet reception block 408 starts receiving the multicast IP packets having the destination IP address specified as the multicast IP address 604 (in step 708) immediately after the multicast router 104 starts transferring the multicast packets, and transfers the received packets to the failure detection block 409.

When one of the multicast IP packets is received, the failure detection block 409 resets a packet arrival monitoring timer (in step 709). The packet arrival monitoring timer is reset each time a multicast IP packet is received.

The failure detection block 409 analyzes the data of the received multicast IP packet, extracts the sequence number 804 (in step 710), and temporarily saves the sequence number as the last received sequence number, together with the content management information 301, in the temporary content information storage block 404. This step is carried out each time the sequence number 804 in the received multicast IP packet is incremented.

The multicast packet creation block 406 of the standby content server 103 may create a multicast IP packet in the same way as in the active content server 102 or may not create it. If created, the multicast IP packet can be prevented from being transferred to the transmission block 407 or from being sent by the transmission block 407.

(3) Failure

Suppose that the multicast IP packet transmission is interrupted (in step 711) because of a failure occurring in the active content server 102 before the content delivery finishes.

The standby content server 103 stops the packet arrival monitoring timer when the content end point indicated by the delivery end information 606, which was received as a part of the delivery start request message from the controller 101 (in step 702) and stored in the temporary content information storage block 404, is reached.

If the multicast IP packet transmission is interrupted because of a failure occurring in the active content server 102, no multicast IP packets are received, and the packet arrival monitoring timer managed by the failure detection block 409 of the standby content server 103 times out before the end point indicated by the delivery end information 606 is reached.

At the timeout of the packet arrival monitoring timer, the failure detection block 409 of the standby content server 103 detects the nonarrival of packets (in step 712) and judges that the content delivery becomes impossible because of a failure occurring in the active content server 102.

The failure detection block 409 of the standby content server 103 informs the main control block 401 of the fact that the nonarrival of packets has been detected.

The main control block 401 judges whether a failure has occurred, in accordance with the delivery end information 606 in the temporary content information storage block 404 and the time when the nonarrival of packets was detected. If it is judged that a failure has occurred, the main control block 401 takes out the last received sequence number, which was extracted from the multicast IP packet received by the failure detection block 409 and stored temporarily in the temporary content information storage block 404, and reports the sequence number to the delivery start point determination block 410, in order to indicate how far the content delivery has been normally performed.

The delivery start point determination block 410 determines the data field of which sequence number is the last received sequence number reported from the main control block 401 plus 1, among the content data 501, as the delivery start point of the standby content server 103 (in step 713), and reports the sequence number information as the delivery start sequence number to the multicast packet creation block 406. The multicast packet creation block 406 reports also the multicast IP address 604 and the port number 605, which are required to create a multicast IP packet.

The multicast packet creation block 406 takes out a data field having the sequence number matching the delivery start sequence number reported from the delivery start point determination block 410, from the content data 501 stored in the content data storage block 405, as the delivery start point of the standby content server 103. A multicast IP packet is created (in step 714) by specifying the data field as the content data field 805 and the sequence number of the content in the sequence number field 804 and adding the RTP header field 803, the UDP header field 802 where the port number 605 is specified as the destination port number, and the IP header field 801 where the multicast IP address 604 is specified as the destination IP address.

In the description given above, the progress of the content delivery is indicated by the sequence number, but the same information can be indicated also by time (absolute time or the like). In that case, content data using time information instead of the sequence number, and a multicast IP packet need to be used.

The multicast IP packet created by the multicast packet creation block 406 is sent by the transmission block 407 (in step 715). The multicast IP packets are created and sent successively until the content data ends.

3. Second Embodiment

(1) Multicast Packet Delivery

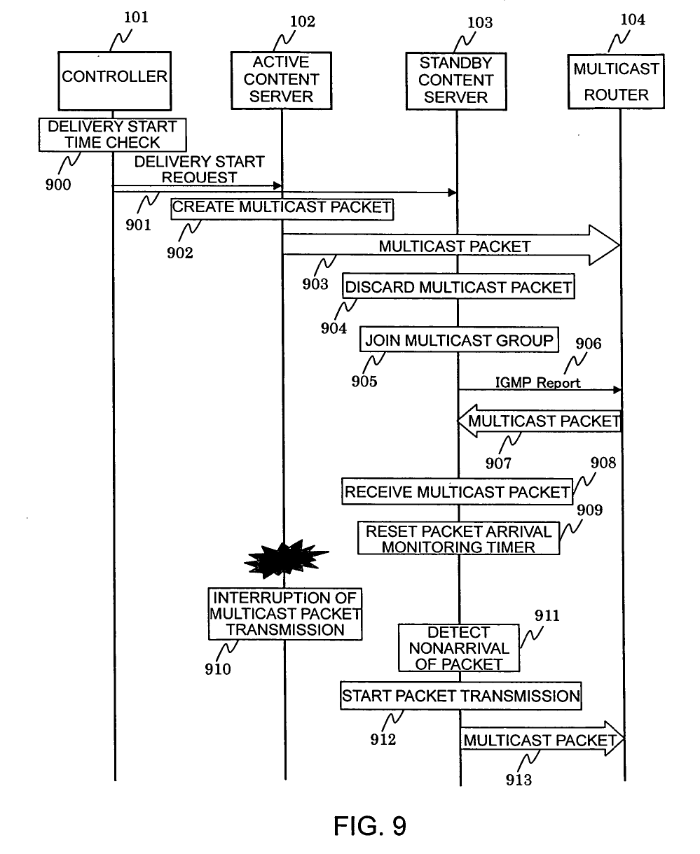

The standby content server may reproduce the content from the delivery start point as described below. FIG. 9 shows an example of operation.

As described with reference to FIG. 7, the controller 101 makes a delivery start time check (in step 900). When the content delivery start time is reached, the controller 101 sends a delivery start request message to the active content server 102 and the standby content server 103 (in step 901).

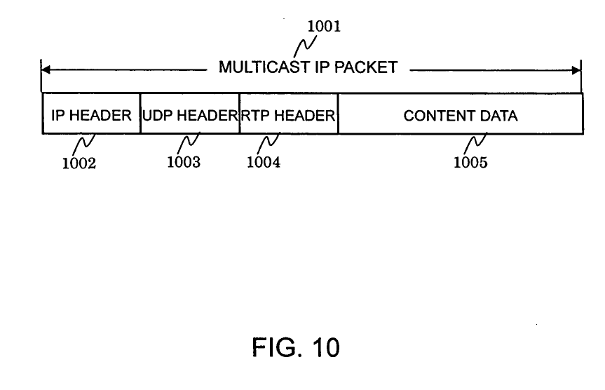

The active content server 102 receives the delivery start request message from the controller 101. In the active content server 102, the multicast packet creation block 406 creates multicast IP packets (in step 902) and sends the multicast IP packets through the transmission block 407 (in step 903), as described with reference to FIG. 7. The multicast IP packets created here have the structure of a multicast IP packet 1001 shown in FIG. 10.

FIG. 10 shows the format of the multicast IP packet 1001.

The multicast IP packet 1001 includes a content data field 1005, an RTP header field 1004, an UDP header field 1003, and an IP header field 1002. The sequence number field 804 of the multicast IP packet structure shown in FIG. 8 is deleted, and the additional information is reduced accordingly.

When the active content server 102 receives the delivery start request message, the standby content server 103 receives the delivery start request message from the controller 101 (in step 901). The multicast packet creation block 406 of the standby content server 103 creates a multicast IP packet 1001 but discards the multicast IP packet without transferring it to the transmission block 407 (in step 904). The multicast packet creation block 406 of the standby content server 103 repeats the steps of creating and discarding a multicast IP packet.

The standby content server 103 joins a multicast group (in step 905), sends an IGMP Report message (in step 906), and starts receiving the multicast IP packets from the active content server 102 (in step 908), as described with reference to FIG. 7. Each time a multicast IP packet is received, the packet arrival monitoring timer is reset (in step 909).

Since a multicast IP packet 1001 does not include a sequence number, the processing to store the sequence number is not performed in the standby content server 103.

(2) Failure

If multicast IP packet transmission is interrupted (in step 910) because of a failure occurring in the active content server 102, the packet arrival monitoring timer of the standby content server 103 times out, and the nonarrival of packet is detected (in step 911). The failure detection block 409 detects the failure in the active content server 102 by detecting the nonarrival of packet and gives an instruction to start multicast IP packet transmission, to the multicast packet creation block 406 through the main control block 401, so that the standby content server 103 starts sending the multicast IP packets. The processing is the same as in the first embodiment.

After the instruction to start multicast IP packet transmission is received from the main control block 401, the multicast packet creation block 406 does not discard any more but transfers created multicast IP packets to the transmission block 407 and starts the multicast IP packet transmission (in step 912).

The present invention can be applied to content delivery using a variety of wired and wireless networks and a variety of wired and wireless communication terminals.

What is claimed is:

1. A multicast delivery method for a multicast delivery system,
the multicast delivery system comprising:
an active content server and a standby content server for delivering a multicast packet containing content data; and
a multicast router for receiving the multicast packet delivered by the active content server and the standby content server and transferring the multicast packet to an interface corresponding to a multicast destination address, and
the multicast delivery method comprising the steps of:
the active content server holding content data and content management information that includes content identification information, a multicast content delivery destination address, and delivery end information, and delivering the multicast packet containing multicast management information and the content data through the multicast router;
the standby content server holding the same content management information and content data as the active content server;
the standby content server joining a multicast group of the multicast packet delivered by the active content server through the multicast router, in accordance with the content identification information and the multicast destination address of the multicast management information;
the standby content server receiving the multicast packet delivered by the active content server through the multicast router; and
if an interruption of the multicast packet delivery from the active content server is detected, the standby content server delivering the multicast packet containing the multicast management information and content data not delivered due to the interruption, through the multicast router on behalf of the active content server.

2. A multicast delivery method according to claim 1, further comprising the step of the active content server and the standby content server receiving a content delivery start request or a content delivery stop request specifying common content management information and storing the content management information internally.

3. A multicast delivery method according to claim 1, wherein the active content server specifies a sequence number of each content data item included in one content or lapse-of-time information indicating the lapse of time since the beginning of content delivery, in the multicast packet, and delivers the multicast packet with the sequence number or the lapse-of-time information added.

4. A multicast delivery method according to claim 3, wherein the standby content server detects an interruption of content delivery from the active content server by detecting the nonarrival of the multicast packet delivered by the active content server;
if an interruption of content delivery is detected, the standby content server determines the interruption point where the content delivery is interrupted, in accordance with the sequence number or the lapse-of-time information in the multicast packet received earlier; and
the standby content server resumes multicast packet delivery from the interruption point.

5. A multicast delivery method according to claim 1, wherein the standby content server does not send but discards created multicast packet while the active content server is normally delivering the content.

6. A multicast delivery method according to claim 5, wherein the standby content server switches the packet discard processing to the packet transmission processing if an interruption of multicast delivery from the active content server is detected while the multicast packet is being discarded.

7. A multicast delivery system comprising:
an active content server and a standby content server for delivering a multicast packet containing content data; and
a multicast router for receiving the multicast packet delivered by the active content server and the standby content server and transferring the multicast packet to an interface corresponding to a multicast destination address,
wherein the active content server holds content data and content management information that includes content identification information, a multicast content delivery destination address, and delivery end information, and delivers the multicast packet containing multicast management information and the content data through the multicast router;
the standby content server holds the same content management information and content data as the active content server;
the standby content server joins a multicast group of the multicast packet delivered by the active content server through the multicast router, in accordance with the content identification information and the multicast destination address of the multicast management information;
the standby content server receives the multicast packet delivered by the active content server through the multicast router; and
if an interruption of the multicast packet delivery from the active content server is detected, the standby content server delivers the multicast packet containing the multicast management information and content data not delivered due to the interruption, through the multicast router on behalf of the active content server.

8. A multicast delivery system according to claim 7, further comprising a controller for giving a content delivery start instruction or a content delivery stop instruction to the active content server and the standby content server, with common content management information specified.

9. A content server for delivering a multicast packet containing content data through a multicast router for transferring the multicast packet to an interface corresponding to a multicast destination address;
the content server, when acting as an active content server, holding content data and content management information that includes content identification information, a multicast content delivery destination address, and delivery end information, and delivering the multicast packet containing the content data and multicast management information through the multicast router;
the content server, when acting as a standby content server, holding the same content data and content management information as the active content server;
the standby content server joining a multicast group of the multicast packet delivered by the active content server through the multicast router, in accordance with the content identification information and the multicast destination address of the multicast management information;
the standby content server receiving the multicast packet delivered by the active content server through the multicast router; and
if an interruption of the multicast packet delivery from the active content server is detected, the standby content server delivering the multicast packet containing the multicast management information and content data not delivered due to the interruption, through the multicast router on behalf of the active content server.

10. A content server according to claim 9, the content server receiving a content delivery start request or a content delivery stop request with common content management information specified and storing the content management information internally, when acting as the active content server or the standby content server.
